(19) United States
(12) Patent Application Publication
(10) Pub. No.: US 2006/0042138 A1
(43) Pub. Date: Mar. 2, 2006

(54) Real estate sign post made of PVC pipe

(76) Inventor: Michael James Lavelle, Glendale, AZ (US)

Correspondence Address: MICHAEL J. LAVELLE, 7113 W. POTTER DR, GLENDALE, AZ, 85308, US

(21) Appl. No.: 10/932,638

(22) Filed: Sep. 2, 2004

(51) Int. Cl. G09F 15/02

(52) U.S. Cl. 40/607.09

(57) ABSTRACT

A real estate sign post is comprised of three principal components, namely a lower PVC tubular member vertically connected to a PVC cross tee and an upper PVC tubular member that is horizontally connected to said cross tee. Also attached to the horizontal PVC tubular member are a set of eyebolts and S-hooks to attach a hanging realtor sign. The third PVC tubular member is to be placed in the ground vertically and affixed to the lower end of the vertical tube member of the sign post to firmly support the sign post at the property.

### BACKGROUND OF INVENTION

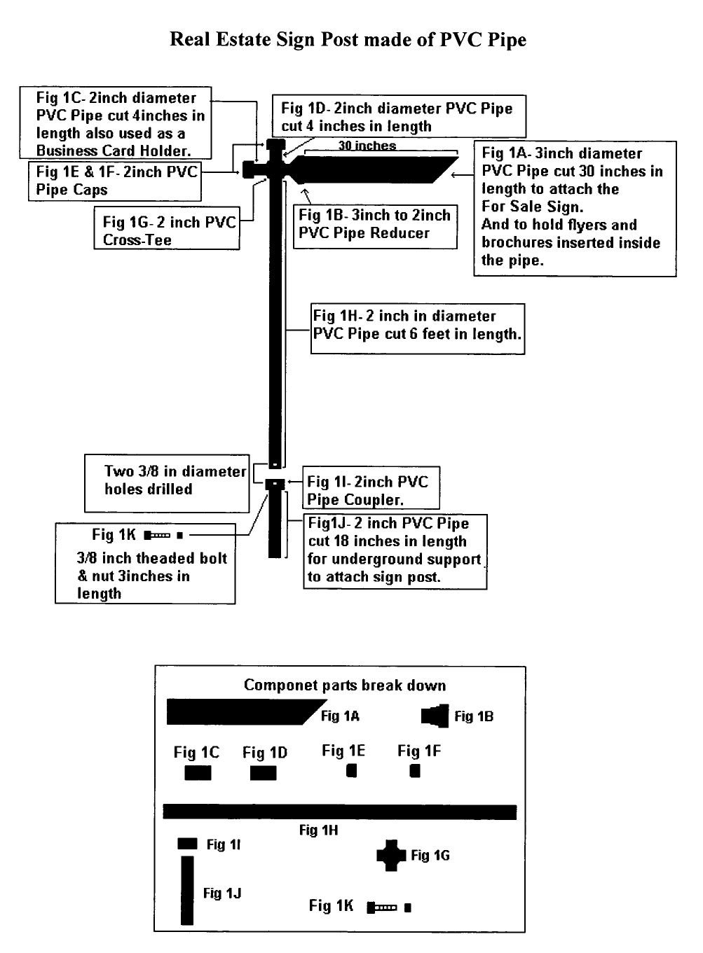

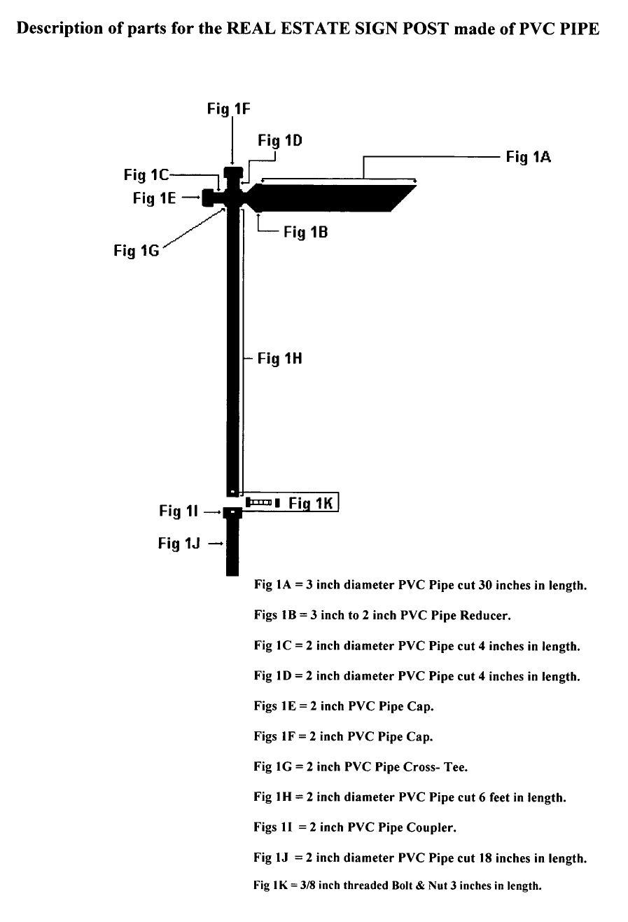

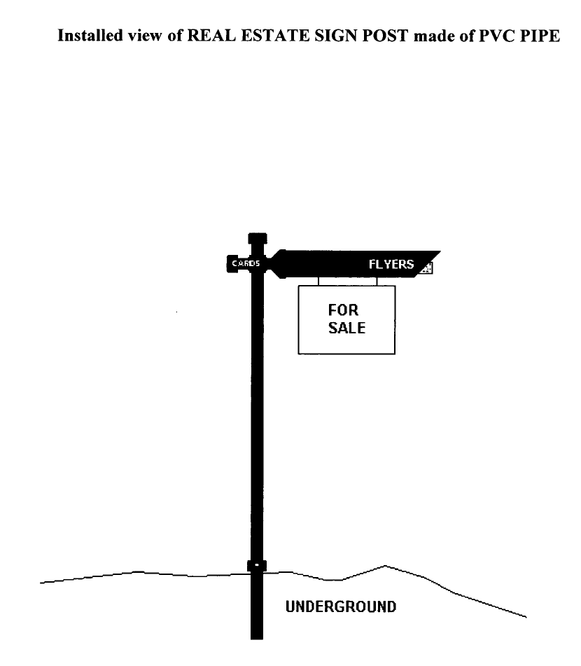

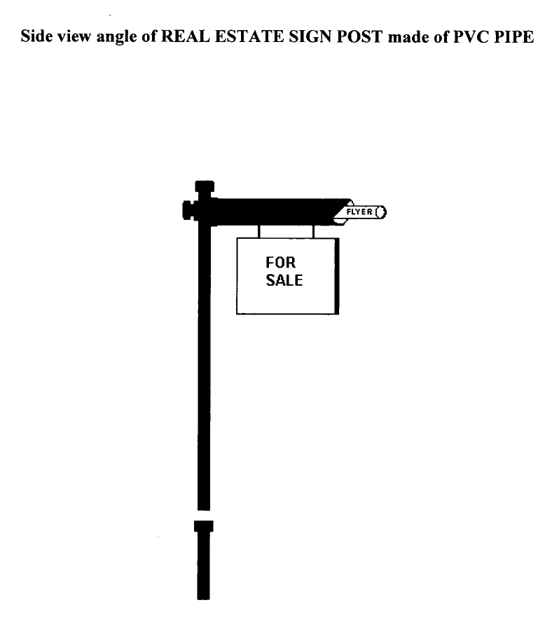

This real estate signpost is more efficient than the old wood and metal versions. This post is lighter in weight and easier to handle and install. With the ground support apparatus you do not have to handle the whole post to install it, unlike those made of wood and metal. You just simply dig a post hole insert the ground support then insert the sign post into top of ground support. Secure it by using one ⅜ bolt and a nut 3 inches in length though the pre-drilled holes in the top of the ground support through the bottom of the signpost. In FIG. 1A the 3-inch diameter PVC pipe arm has two functions: it is used to attach the For Sale sign and as a flyer/brochure holder. This eliminates the need to have a flyer tube or flyer box attached separately.

In FIG. 1C the 2-inch diameter PVC Pipe can be used as a business cardholder by removing FIG. 1E, the 2-inch cap. This signpost is also easy to remove, just loosen and remove the ⅜ bolt and nut. Pull upwards on the post to detach from the ground support. To remove ground support simply insert a screw driver though the ⅜ inch bolt hole at the top of ground support turning back and forth and pulling upwards.

This signpost looks more attractive than the commonly used real estate signposts. It never needs to be painted and it will not rust or rot like the traditional wood and metal post.

There are also some environmental advantages. Using it will not only save trees but it will not pollute the soil as commonly used sign posts do with rust and the chemicals used to treated them.

### DESCRIPTION

(1) This sign post consist of 10 components all made of PVC.

(2) All of these components are attached together with PVC Cement and one ⅜ threaded bolt and nut 3-inches in length to attach FIG. 1H to FIG. 1I ground support.

(3) FIG. 1A consists of a 3-inch diameter PVC Pipe cut 30 inches in length.

(4) FIG. 1B is a 3-inch to 2-inch PVC Reducer that is then attached to FIG. 1A.

(5) FIG. 1C consists of 2-inch diameter PCV Pipe cut 4-inches in length.

(6) FIG. 1D consists of 2-inch diameter PCV Pipe cut 4-inches in length.

(7) FIG. 1E is 2-inch diameter PVC Caps that attach to FIG. 1C.

(8) FIG. 1 F is 2-inch diameter PVC Caps that attach to FIG. 1D.

(9) FIG. 1G is a 2-inch PVC Cross-Tee to which FIGS. 1A, 1B, 1C and 1D are attached to.

(10) FIG. 1H consists of a 2-inch PVC Pipe 6 feet in length, which also is attached to FIG. 1G.

(11) FIG. 1I consists of a 2-inch PVC Coupler.

(12) FIG. 1J consists of a 2-inch diameter PVC Pipe 18 inches in length.

(13) FIGS. 1I and 1J are attached together to form the underground support for the signpost.

(14) Then FIG. 1K a ⅜ inch threaded bolt & nut 3 inches in length secures the signpost.

(15) Thus completing the signpost.

What I claim is:

1. A device for holding a Real Estate sign produced of PVC Pipe. Consisting of three PVC pipes. Two are joined together with a Pipe Cross Tee produced of PVC. One pipe is affixed to the Cross tee in a horizontal position to hold said Real Estate sign and also printed material such as fliers and or brochures. The second pipe is affixed to the said cross tee in a vertical position to support this device thus comprising a sign post to display Real Estate Signs and printed material.
The third device I claim is a pipe produced of PVC that is placed in ground in a vertical position. And is affixed to the lower member of said vertical pipe of the sign post with a ⅜ threaded bolt. Thus securing the sign post to property grounds.
What I claim is there are six other components produced of PVC pipe and PVC material such as PVC caps coupler, reducers and small lengths of PVC Pipe. Thus completing the said Real Estate sign post.
